(19) United States
(12) Patent Application Publication
(10) Pub. No.: US 2007/0102478 A1
(43) Pub. Date: May 10, 2007

(54) Optimal imaging system and method for a stencil printer

(75) Inventor: David P. Prince, Wakefield, RI (US)

Correspondence Address: LOWRIE, LANDO & ANASTASI, RIVERFRONT OFFICE, ONE MAIN STREET, ELEVENTH FLOOR, CAMBRIDGE, MA, 02142, US

(73) Assignee: Speedline Technologies, Inc., Franklin, MA (US)

(21) Appl. No.: 11/345,727

(22) Filed: Feb. 2, 2006

Related U.S. Application Data
(63) Continuation-in-part of application No. 11/272,192, filed on Nov. 10, 2005.

(51) Int. Cl. B23K 1/08; B23K 37/06; B23K 31/00

(52) U.S. Cl. 228/39; 228/105; 228/180.22

(57) ABSTRACT

A stencil printer for depositing solder paste onto an electronic substrate includes a frame and a stencil coupled to the frame. A dispenser is coupled to the frame, with the dispenser and the stencil being configured to deposit solder paste onto the plurality of pads of the electronic substrate. An imaging system is configured to capture images of regions of interest of at least one of the electronic substrate and the stencil. The stencil printer further includes a controller coupled to the imaging system, with the controller being configured to control movement of the imaging system to capture images of regions of interest of at least one of the electronic substrate and the stencil extending generally along a first axis before moving the imaging system in another direction. A method for dispensing material on a substrate is further disclosed.

### RELATED APPLICATIONS

This application is a continuation-in-part of U.S. patent application Ser. No. 11/272,192, filed on Nov. 10, 2005, entitled “IMAGING SYSTEM AND METHOD FOR A STENCIL PRINTER,” which is owned by the assignee of the present invention and incorporated herein by reference in its entirety.

### FIELD OF THE INVENTION

The present invention relates to apparatuses and methods for dispensing material, and more particularly to an apparatus and method for optimally scanning solder paste dispensed onto metallic pads of an electronic substrate, such as a printed circuit board.

### BACKGROUND OF THE INVENTION

In typical surface-mount circuit board manufacturing operations, a stencil printer is used to print solder paste onto a circuit board. Typically, a circuit board having a pattern of metallic pads or some other conductive surface onto which solder paste will be deposited is automatically fed into the stencil printer and one or more small holes or marks on the circuit board, called fiducials, is used to properly align the circuit board with a stencil or screen of the printer prior to the printing of solder paste onto the circuit board. After the circuit board is aligned, the board is raised to the stencil (or in some configurations, the stencil is lowered to the circuit board), solder paste is dispensed onto the stencil, and a wiper blade (or squeegee) traverses the stencil to force the solder paste through apertures formed in the stencil and onto the board.

In some prior art stencil printers, a dispensing head delivers solder paste between first and second wiper blades, wherein during a print stroke one of the wiper blades is used to move or roll solder paste across the stencil. The first and second wiper blades are used on alternating boards to continually pass the roll of solder paste over the apertures of a stencil to print each successive circuit board. The wiper blades are typically at a predetermined angle with the stencil to apply downward pressure on the solder paste to force the solder paste through the apertures of the stencil.

After solder paste is deposited onto the circuit board, an imaging system is employed to take images of areas of the circuit board and/or the stencil for, in certain instances, the purpose of inspecting the accuracy of the deposit of solder paste on the pads of the circuit board. Another application of the imaging system involves the aforementioned aligning of the stencil and the circuit board prior to printing in order to register the openings of the stencil with the electronic pads of the circuit board. Such imaging systems are disclosed in U.S. Pat. No. RE34,615 and U.S. Pat. No. 5,060,063, both to Freeman, which are owned by the assignee of the present invention. FIG. 1 illustrates a prior art imaging system, generally indicated at 10, which may be positioned adjacent the print nest (not shown) or attached to a gantry (not shown) to enable the imaging system to move over the print nest between a circuit board 12 and a stencil 14. Regardless of its particular configuration, the imaging system 10 is designed to take images of predefined areas of the circuit board 12 and/or the stencil 14 to either inspect the circuit board and/or the stencil or to align the stencil with the circuit board, for example.

As shown in FIG. 1, the imaging system 10 comprises an electronic camera 16 having a lens assembly 18, two illumination devices 20, 22, two beam splitters 24, 26 and another beam splitter 28 that includes an additional mirrored surface to redirect light toward the lens assembly 18 of the camera 16. To capture an image of a predefined area of the circuit board 12, the illumination device 20 is operated to generate a beam of light that reflects off of the beam splitter 24 towards the circuit board. Light is then reflected off of the circuit board 12 back through the beam splitter 24 to the beam splitter 28, which in turn reflects the light towards lens assembly 18, and finally to the camera 16. The image of the circuit board 12 is then captured by the camera 16. Similarly, to image a predefined area of the stencil 14, the illumination device 22 is employed to generate a beam of light that reflects off of the other beam splitter 26 towards the stencil. Light reflected off of the stencil 14 is directed back through beam splitter 26 to the middle beam splitter 28 and then to the lens assembly 18 and to the camera 16 to capture the image.

With typical imaging systems, the system 10 must be moved over an area, stopped to enable the camera 16 to take an image without blur, and moved to the next area requiring imaging. FIG. 2 represents the movement of the imaging system 10, which represents schematically the velocity of the imaging system versus time. As shown, typical imaging systems come to a complete stop (i.e., velocity is zero) in order to take an image. When stopping the imaging system, further time is required to ensure that any vibration or oscillation caused by the stopping action of the imaging system gantry does not adversely affect the quality of the image taken by the camera 16. Thus, inspection of the circuit board, for example, may be a relatively lengthy process in that a multitude of areas of the circuit board must be imaged with the imaging system being stopped and moved multiple times. The captured images are next compared with corresponding areas of the stencil or areas stored by the controller of the stencil printer to determine the accuracy of the print. As a result, the sequential imaging of the areas of the circuit board may take an excessive amount of time since the imaging system must be moved over the area requiring imaging, stopped to image the area, and then moved to the next area requiring imaging.

For example, FIG. 3 represents a typical circuit board 12 requiring imaging. If the time required to properly expose an image of a region of interest is approximately 30 milliseconds and the time required to move the imaging system 10 to an adjacent region of interest is approximately 100 milliseconds, then overall time between acquisitions is approximately 130 milliseconds. In part, the image acquisition rate of the imaging system 10 is limited by the time needed to properly expose the light-sensitive electronics at the focal plane of the camera 16. Exposure time is directly related to the amount of light produced by the illumination devices, the relative brightness of the features of interest, and the lens aperture ratio or “f-stop” of the lens assembly 18. Most illumination devices that are relatively small due to space constraints are capable of generating only a relatively low level of light thus requiring a longer integration time to achieve proper exposure. To increase the speed of imaging, it is known within some imaging systems to employ two cameras, one camera to image the stencil and another camera to image the circuit board, thus reducing the time between images to align or inspect the stencil and the circuit board. However, with continuing efforts to reduce processing times at all stages of the circuit board assembly, even the provision of two cameras is often too slow for assembly lines requiring faster production rates. There is presently a need to further reduce the time it takes to image circuit boards and stencils for inspection and/or alignment purposes.

Another cause of excessive time to inspect an entire circuit board is due to inefficient inspection paths generated by the controller for the inspection system. FIG. 4 illustrates a typical inspection path chosen by the controller (or pre-programmed into the controller by the operator) for the circuit board 12 shown in FIG. 3, having solder paste deposited on the metallic pads. As shown, the inspection path involves grouping the electronic components into several clusters. One such cluster is designated as 13 in FIGS. 3 and 4. The imaging system captures images of the circuit board within each cluster by sequentially moving the imaging system from component to component to capture each region of interest. For the circuit board 12 illustrate in FIG. 3, there are 921 regions of interest or sites, each requiring an image. Using present inspection techniques, it takes approximately 260 seconds to inspect the entire circuit board.

### SUMMARY OF THE INVENTION

One aspect of the invention is directed to a stencil printer for depositing solder paste onto a plurality of pads of an electronic substrate. In a certain embodiment, the stencil printer comprises a frame and a stencil coupled to the frame. The stencil has a plurality of apertures formed therein. A dispenser is coupled to the frame, with the dispenser and the stencil being constructed and arranged to deposit solder paste onto the plurality of pads of the electronic substrate. An imaging system is constructed and arranged to capture images of regions of interest of at least one of the electronic substrate and the stencil. The stencil printer further comprises a controller coupled to the imaging system, with the controller being constructed and arranged to control movement of the imaging system to capture images of regions of interest of at least one of the electronic substrate and the stencil extending generally along a first axis before moving the imaging system in another direction.

Embodiments of the invention may be directed to after capturing images of all of the regions of interest along the first axis, the controller being further constructed and arranged to control movement of the imaging system to capture images of regions of interest extending generally along a second axis, which is generally parallel to and spaced a distance from the first axis. The imaging system is constructed and arranged to capture an image of solder paste on a pad of the electronic substrate within the area. In one embodiment, the imaging system comprises at least one camera, at least one lens assembly, at least one illumination device and at least one optical path adapted to reflect light between the at least one illumination device, one of the stencil and the electronic substrate, the at least one lens assembly, and the at least one camera. The optical path may comprise at least one beam splitter and a mirror. In another embodiment, the imaging system comprises a first camera, a first lens assembly, a first illumination device and a first optical path adapted to reflect light between the first illumination device, the electronic substrate, the first lens assembly and the first camera, and a second camera, a second lens assembly, a second illumination device, and a second optical path adapted to reflect light between the second illumination device, the stencil, the second lens assembly and the second camera. The controller may be further constructed and arranged to control the movement of the imaging system to simultaneously capture images of regions of interest of the electronic substrate and the stencil. The controller may be further constructed and arranged to control the movement of the imaging system to capture images of regions of interest while maintaining a minimum velocity above zero when moving from one region of interest to a next region of interest. In addition, the controller may comprise a processor programmed to perform texture recognition of the electronic substrate to determine the accuracy of the solder paste deposits on the pads of the electronic substrate. In another embodiment, the stencil printer may further comprise a support assembly coupled to the frame, the support assembly being adapted to support the electronic substrate in a printing position. In a further embodiment, the stencil printer further comprises a gantry system coupled to the imaging system and the frame, the gantry system being constructed and arranged to move the imaging system under the direction of the controller.

Another aspect of the invention is directed to a method for dispensing solder paste onto electronic pads of an electronic substrate. In one embodiment, the method comprises: delivering an electronic substrate to a stencil printer; positioning the electronic substrate in a print position; positioning a stencil onto the electronic substrate; performing a print operation to deposit solder paste onto the pads of the electronic substrate; capturing images of regions of interest of one of the electronic substrate and the stencil generally along a first axis; and capturing images of regions of interest of the one of the electronic substrate and the stencil generally along a second axis, which is generally parallel to and spaced a distance from the first axis.

Embodiments of the method may be directed to moving an imaging system from one region of interest to a next region of interest. The method may further comprise maintaining a minimum velocity above zero when moving the imaging from one region of interest to the next region of interest. The method may also comprise, after capturing images of regions of interest of one of the electronic substrate and the stencil, moving the imaging system in a direction that is generally orthogonal to the first axis. In another embodiment, the method may further comprise assembling the captured images of the regions of interest. A texture recognition sequence of the at least one area to determine the accuracy of the solder paste deposits on the pads of the electronic substrate may be further performed.

A further aspect of the invention is directed to a stencil printer for depositing solder paste onto a plurality of pads of an electronic substrate. The stencil printer comprises a frame and a stencil coupled to the frame. The stencil has a plurality of apertures formed therein. The stencil printer further comprises a dispenser coupled to the frame, with the dispenser and the stencil being constructed and arranged to deposit solder paste onto the plurality of pads of the electronic substrate. An imaging system is constructed and arranged to capture images of regions of interest of at least one of the electronic substrate and the stencil. The stencil printer also comprises means for controlling the movement of the imaging system to capture images of regions of interest of at least one of the electronic substrate and the stencil extending generally along a first axis before moving the imaging system in a direction that is generally orthogonal to the first axis.

Embodiments of the stencil printer include the provision of the means for controlling the movement of the imaging system comprising a controller coupled to the imaging system. The controller is constructed and arranged to control movement of the imaging system to capture images of regions of interest extending generally along a second axis, which is generally parallel to and spaced a distance from the first axis. The imaging system is constructed and arranged to capture an image of solder paste on a pad of the electronic substrate within the area. In one embodiment, the imaging system comprises at least one camera, at least one lens assembly, at least one illumination device and at least one optical path adapted to reflect light between the at least one illumination device, one of the stencil and the electronic substrate, the at least one lens assembly, and the at least one camera. The optical path may comprise at least one beam splitter and a mirror. In another embodiment, the imaging system comprises a first camera, a first lens assembly, a first illumination device and a first optical path adapted to reflect light between the first illumination device, the electronic substrate, the first lens assembly and the first camera, and a second camera, a second lens assembly, a second illumination device, and a second optical path adapted to reflect light between the second illumination device, the stencil, the second lens assembly and the second camera. The controller may be further constructed and arranged to control the movement of the imaging system to simultaneously capture images of regions of interest of the electronic substrate and the stencil. The controller may be further constructed and arranged to control the movement of the imaging system to capture images of regions of interest while maintaining a minimum velocity above zero when moving from one region of interest to a next region of interest. In addition, the controller may comprise a processor programmed to perform texture recognition of the electronic substrate to determine the accuracy of the solder paste deposits on the pads of the electronic substrate. In another embodiment, the stencil printer may further comprise a support assembly coupled to the frame, the support assembly being adapted to support the electronic substrate in a printing position. In a further embodiment, the stencil printer further comprises a gantry system coupled to the imaging system and the frame, the gantry system being constructed and arranged to move the imaging system under the direction of the controller.

Yet another aspect of the invention is directed to a stencil printer for depositing solder paste onto a plurality of pads of an electronic substrate comprising a frame and a stencil coupled to the frame. The stencil has a plurality of apertures formed therein. A support assembly is coupled to the frame, with the support assembly being adapted to support the electronic substrate in a printing position. A dispenser is coupled to the frame, with the dispenser and the stencil being constructed and arranged to deposit solder paste onto the plurality of pads of the electronic substrate. An imaging system is constructed and arranged to capture images of regions of interest of at least one of the electronic substrate and the stencil. A gantry system is coupled to the imaging system and the frame, with the gantry system being constructed and arranged to move the imaging system. In one embodiment, the stencil printer further comprises a controller coupled to the imaging system and the gantry system, with the controller being constructed and arranged to control movement of the imaging system to capture images of regions of interest extending generally along a first axis in a first direction and to sequentially control movement of the imaging system to capture images of regions of interest extending generally along a second axis, which is generally parallel to and spaced from the first axis, in a second direction.

Embodiments of the stencil printer may include the provision of the controller comprising a processor programmed to perform texture recognition of the electronic substrate to determine the accuracy of the solder paste deposits on the pads of the electronic substrate. In addition, the controller may be further constructed and arranged to control the movement of the imaging system to simultaneously capture images of regions of interest of the electronic substrate and the stencil, as well as to control the movement of the imaging system to capture images of regions of interest while maintaining a minimum velocity above zero when moving from one region of interest to a next region of interest.

### BRIEF DESCRIPTION OF THE DRAWINGS

In the drawings, like reference characters refer to the same or similar parts throughout the different views. The drawings are not necessarily to scale, emphasis instead being placed upon illustrating particular principles, discussed below.

FIG. 1 is a schematic view of a prior art imaging system;

FIG. 2 is a graph representing the velocity versus time of the prior art imaging system;

FIG. 3 is a top plan view of a printed circuit board;

FIG. 4 is a schematic representation of a scan path using prior art approaches;

FIG. 5 is a front perspective view of a stencil printer of an embodiment of the present invention;

FIG. 6 is a schematic view of an imaging system of an embodiment of the present invention;

FIG. 7 is an enlarged schematic view of a camera and lens assembly of the imaging system illustrated in FIG. 6;

FIG. 8 is a graph representing the velocity versus time of the imaging system illustrated in FIG. 6;

FIG. 9 is a schematic representation of a scan path generated in accordance with embodiments of the present invention;

FIG. 10 is a flow diagram of a method of dispensing solder paste onto electronic pads of an electronic substrate of an embodiment of the invention;

FIG. 11 is a schematic view of an imaging system used to perform a texture recognition method of an embodiment of the invention;

FIG. 12 is a schematic representation of a substrate; and

FIG. 13 is a schematic representation of a substrate having solder paste deposited on the substrate.

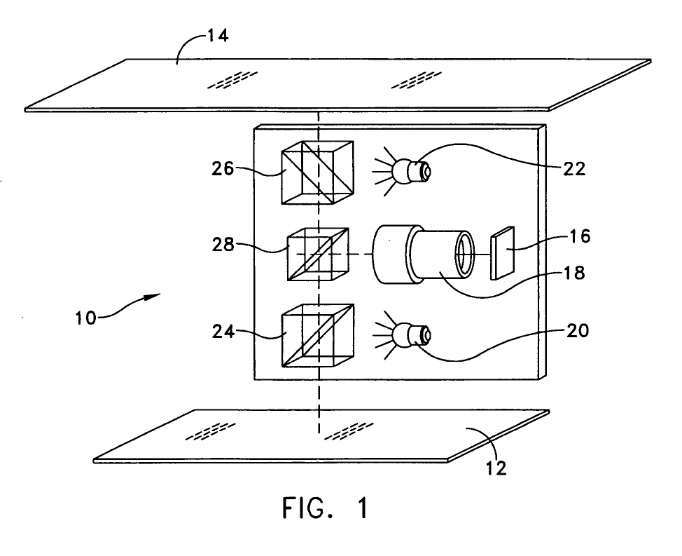

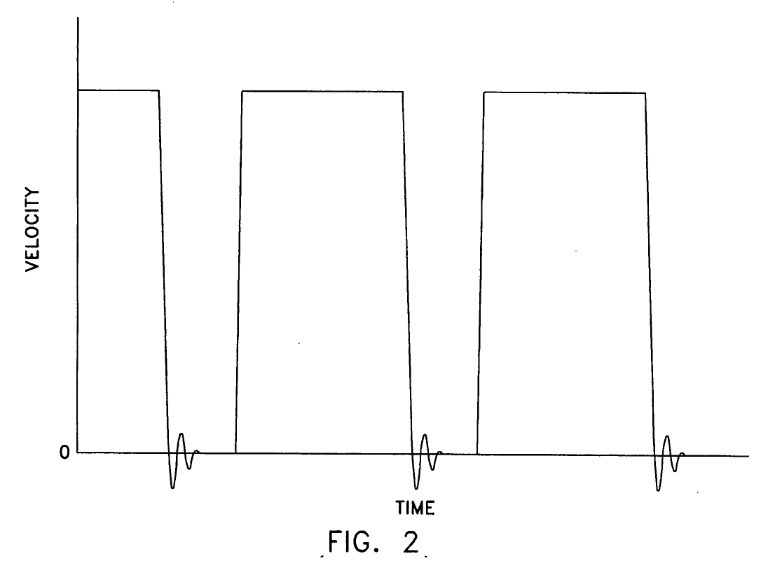

### DETAILED DESCRIPTION OF THE INVENTION

For purposes of illustration, embodiments of the present invention will now be described with reference to a stencil printer used to print solder paste onto a circuit board. One skilled in the art will appreciate that embodiments of the present invention are not limited to stencil printers that print solder paste onto circuit boards, but rather, may be used in other applications requiring dispensing of other viscous materials, such as glues, encapsulents, underfills, and other assembly materials suitable for attaching electronic components onto a circuit board. Thus, any reference to solder paste herein contemplates use of such other materials. Also, the terms “screen” and “stencil” may be used interchangeably herein to describe a device in a printer that defines a pattern to be printed onto a substrate.

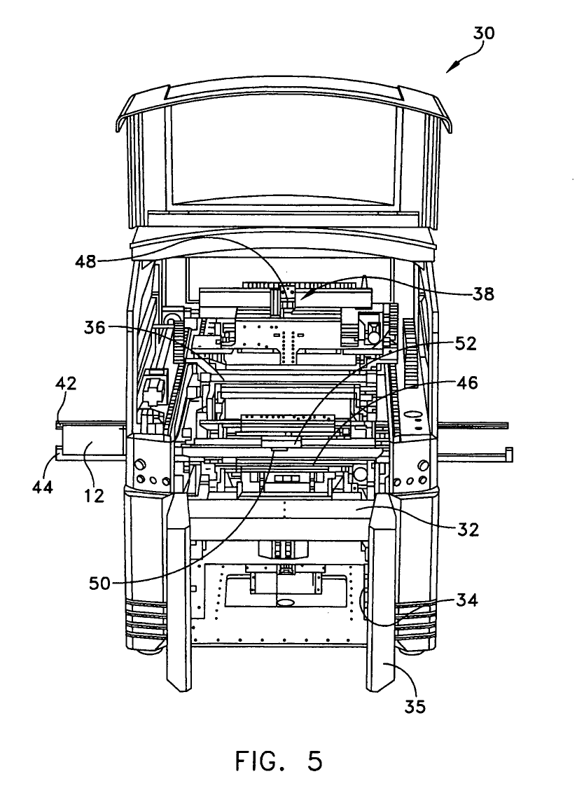

FIG. 5 shows a front perspective view of a stencil printer, generally indicated at 30, in accordance with one embodiment of the present invention. The stencil printer 30 includes a frame 32 that supports components of the stencil printer including a controller 34 located in a cabinet 35 of the stencil printer, a stencil 36, and a dispensing head, generally indicated at 38, for dispensing solder paste. The dispensing head 38 is movable along orthogonal axes by a gantry system (not designated) under the control of the controller 34 to allow printing of solder paste on a circuit board 12.

Stencil printer 30 also includes a conveyor system having rails 42, 44 for transporting the circuit board 12 to a printing position in the stencil printer 30. The stencil printer 30 has a support assembly 46 (e.g., pins, gel membranes, etc.) positioned beneath the circuit board 12 when the circuit board is in the dispensing position. The support assembly 46 is used to raise the circuit board 12 off of the rails 42, 44 to place the circuit board in contact with, or in close proximity to, the stencil 36 when printing is to occur.

In one embodiment, the dispensing head 38 is configured to receive at least one solder paste cartridge 48 that provides solder paste to the dispensing head during a printing operation. In one embodiment, the solder paste cartridge 48 is coupled to one end of a pneumatic air hose in a typical and well known manner. The other end of the pneumatic air hose is attached to a compressor contained within the frame 32 of the stencil printer 30 under the control of the controller 34. The compressor provides pressurized air to the cartridge 48 to force solder paste into the dispensing head 38 and onto the stencil 36. Other configurations for dispensing solder paste onto the stencil may also be employed. For example, in another embodiment, mechanical devices, such as a piston, may be used in addition to, or in place of, air pressure to force the solder paste from the cartridge 48 into the dispensing head 38. In yet another embodiment, a non-pressurized dispensing head may be employed. The controller 34 may be implemented using a personal computer having a suitable operating system (e.g., Microsoft® DOS or Windows®) with application specific software to control the operation of the stencil printer 30 as described herein.

The stencil printer 30 operates as follows. A circuit board 12 is loaded into the stencil printer 30 and delivered to the support assembly 46 using the conveyor rails 42, 44. The circuit board 12 and stencil 36 are then brought into precise alignment and raised by the support assembly 46 into a print position. The dispensing head 38 is then lowered in the Z-direction until it is in contact with the stencil 36. The dispensing head 38 fully traverses the stencil 36 in a first print stroke to force solder paste through apertures of the stencil 36 and onto the circuit board 12. Once the dispensing head 38 has fully traversed the stencil 36, the circuit board 12 is transported by the conveyor rails 42, 44 from the printer 30 so that a second, subsequent circuit board may be loaded into the printer. To print on the second circuit board, the dispensing head 38 may be moved in a second print stroke across the stencil 36 in an opposite direction to that used for the first circuit board.

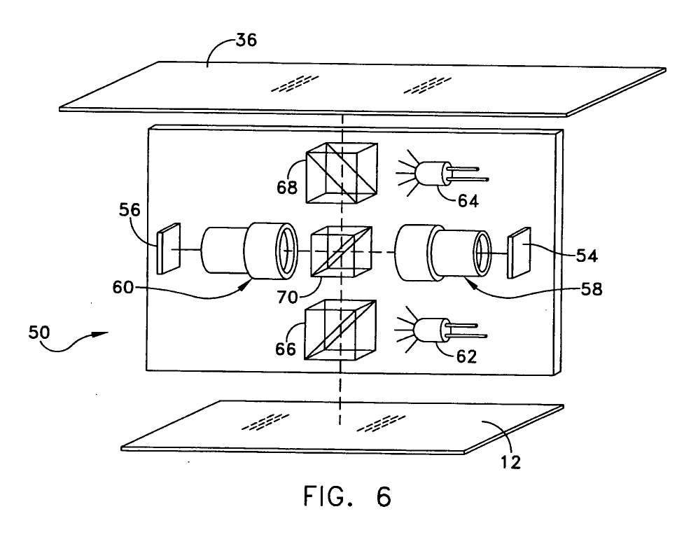

Referring to FIGS. 5 and 6, an imaging system of an embodiment of the present invention is generally designated at 50. As shown in FIG. 5, the imaging system 50 is disposed between the stencil 36 and the circuit board 12. The imaging system 50 is coupled to a gantry system 52, which is further coupled to the frame 32 and may be part of the gantry used to move the dispensing head 28 or provided separately within the stencil printer 30. The construction of the gantry system 52 used to move the imaging system 50 is well known in the art of solder paste printing. In certain embodiments, the arrangement is such that the imaging system may be located at any position below the stencil 36 and above the circuit board 12 to capture an image of predefined areas of the circuit board or the stencil, respectively. In other embodiments, the imaging system may be located above or below the stencil and the circuit board.

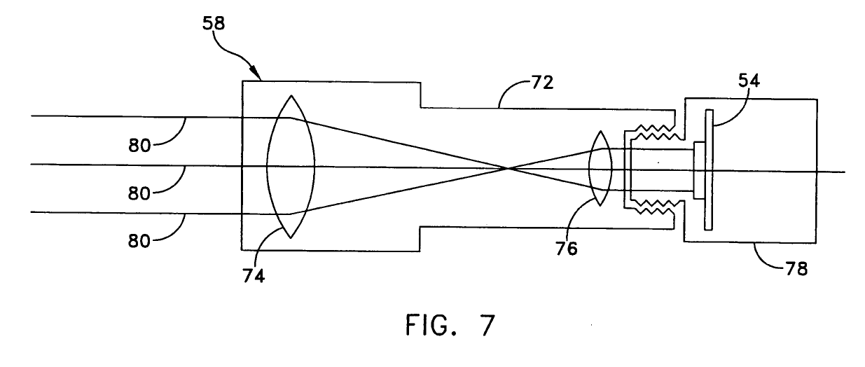

As shown in FIG. 6, the imaging system 50 comprises an optical assembly having two cameras 54, 56, two lens assemblies generally indicated at 58, 60, two illumination devices 62, 64, two beam splitters 66, 68, and a mirror 70. The cameras 54, 56 may be identical in construction with respect to one another, and, in one embodiment, each camera may be a digital CCD camera of the type that may be purchased from Opteon Corporation of Cambridge, Mass. under Model No. CHEAMDPCACELA010100. Further description of the cameras 54, 56 will be provided below with reference to FIG. 7.

In one embodiment, the illumination devices 62, 64 may be one or more light emitting diodes (white light diodes) that are capable of generating an intense amount of light at their respective beam splitter 66, 68. The illumination devices 62, 64 may be of the type sold by Nichia Corporation of Detroit, Mich. under Model No. NSPW310BSB1B2/ST. The beam splitters 66, 68 and the mirror 70, which is a dual mirror with zero beam split, are well known in the art. In other embodiments, xenon and halogen lamps may be used to generate the light required. Fiber optics can also be used to convey light from the remote source to the point of use.

The beam splitters 66, 68 are designed to reflect a portion of the light generated by their respective illumination devices 62, 64 toward the circuit board 12 and the stencil 36, respectively, while further allowing a portion of the light reflected by the circuit board and the stencil pass through to the mirror 70. The optical paths defined between the illumination devices 62, 64 and their respective cameras 54, 56 by means of beam splitters 66, 68 and mirror 70 are well known to a person skilled in the art. In one embodiment, the construction of the optical paths created by the beam splitters 66, 68 and the mirror 70 is substantially similar to the paths disclosed in U.S. Pat. No. 5,060,063, except that mirror 70 is a full mirror (due to the provision of the two cameras 54, 56) and does not allow part of the light to pass therethrough.

Referring to FIG. 7, camera 54 and lens assembly 58 are illustrated. As discussed above, camera 56 may be identical in construction to camera 54. In addition, the construction of lens assembly 60 may be identical in construction to lens assembly 58. Accordingly, the following discussion of camera 54 and lens assembly 58 generally applies for camera 56 and lens assembly 60, respectively. As shown schematically, lens assembly 58 includes a housing 72, a pair of lenses 74, 76 disposed within the housing and an aperture (not shown) disposed between the lenses 74, 76. The lenses 74, 76 together provide the telecentric capability of the lens assembly 58. The collective lens assembly may also be referred to as a “lens,” which is specifically referred to herein as the telecentric lens assembly 58 or 60. The arrangement is such that light reflected from the mirror 70 is directed to the lens assembly 58. Once in the lens assembly 58, the light passes through the first lens 74, through the aperture, through the second lens 76, and on to the image-sensitive region of the camera 54. In one embodiment, the CCD reader of the camera 54 may include an electronic shutter. The camera 54, in part due to the telecentric lens assembly 58, is designed to view an entire predefined area without exhibiting distortion at or near the periphery of the image.

As shown in FIG. 7, the camera 54 is supported by a housing 78, which may be threadably attached to the housing 72 of the lens assembly 58. The housing 72 of the lens assembly 58 and the housing 78 of the camera 54 are in axial alignment with one another so that the image, which is represented in ray-form by lines 80, is accurately directed toward the camera.

Referring back to FIG. 6, the arrangement is such that when taking an image of the circuit board 12, the illumination device 62 generates an intense amount of light toward its respective beam splitter 66. This light is reflected by the beam splitter 66 toward the circuit board 12, and is then reflected back toward the mirror 70. The mirror 70 directs the light to the camera 54, which captures the image of the predefined area of the circuit board 12. The image may be electronically stored or used in real-time so that the image may be manipulated and analyzed by the controller 34 to either detect a defective solder deposit or align the circuit board 12 with the stencil 36, for example.

Similarly, when taking an image of the stencil 36, the illumination device 64 generates a beam of light that is directed toward its respective beam splitter 68. The light is then directed toward the stencil 36 and reflects back through the beam splitter 68 to the mirror 70. The light is then directed toward the telecentric lens assembly 60 and on to the camera 56 to capture the image of the predefined area of the stencil 36. Once captured, the area of the stencil 36 may be analyzed by the controller 34 for inspection purposes (e.g., detecting clogged apertures in the stencil, for example), or compared to an area of the circuit board 12 for alignment purposes. The inspection capability of the imaging system 50 will be described in greater detail below with reference to the description of a texture recognition program.

With the configuration illustrated in FIG. 6, the imaging system 50 is capable of moving from predefined area to predefined area while taking an image in approximately 105 milliseconds, with approximately 100 milliseconds attributable to moving the imaging system from one predefined area to another predefined area and approximately 5 milliseconds attributable to taking the image while maintaining a minimum velocity. Longer and shorter times are possible based on the actual distance and time of flight between acquisitions. It has been found that the imaging system of the invention is capable of taking an image without significant distortion or blurring while maintaining a minimum velocity of at least 1 millimeter per second. In one embodiment, the imaging system is capable of maintaining a minimum velocity of at least 3 millimeters per second. In another embodiment, the imaging system is capable of maintaining a minimum velocity of at least forty-eight millimeters per second. In this case, a xenon illuminator is used to provide a 3.8 micro-second exposure pulse. Although maintaining a minimum velocity, the imaging system 50 cannot travel across the stencil 36 and/or the circuit board 12 more than a distance equivalent to ¼ pixel shift at the image plane of the camera 54 and/or 56. It has been discovered that the imaging system 50, during the exposure interval, may travel an equivalent distance at the image plane up to a ¼ pixel and still provide an acceptable image.

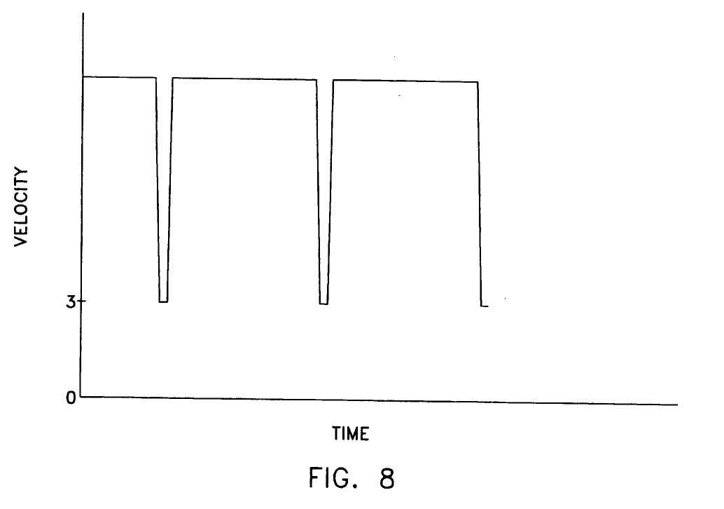

With reference to FIG. 8, in one embodiment, the imaging system 50, when taking an image of either the stencil 36 or the board 12, decelerates to capture the image, but always maintains a minimum, positive velocity. As shown, the imaging system 50, when approaching a predefined area for an image, decelerates, takes the image by opening and closing the electronic equivalent of a shutter, and accelerates to the next predefined area. The combination of intense light and reduced exposure time enables the imaging system to maintain a minimum positive velocity during image capture. Also, since the imaging system 50 maintains a minimum velocity and is not stopped, less vibration or oscillation is introduced, and added time is not needed to ensure the vibration level of the imaging system is below a certain threshold. In one embodiment, the image is captured during a time when the imaging system travels a distance equivalent to less than ¼ pixel at the image plane. Accordingly, the imaging system of the invention enables the stencil printer 30 to quickly image predefined areas of the stencil and/or the circuit board in significantly less time than prior art imaging systems.

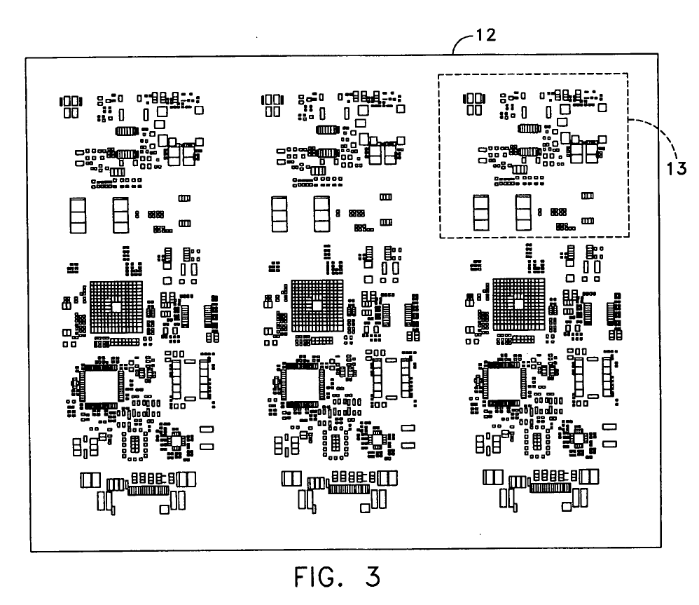

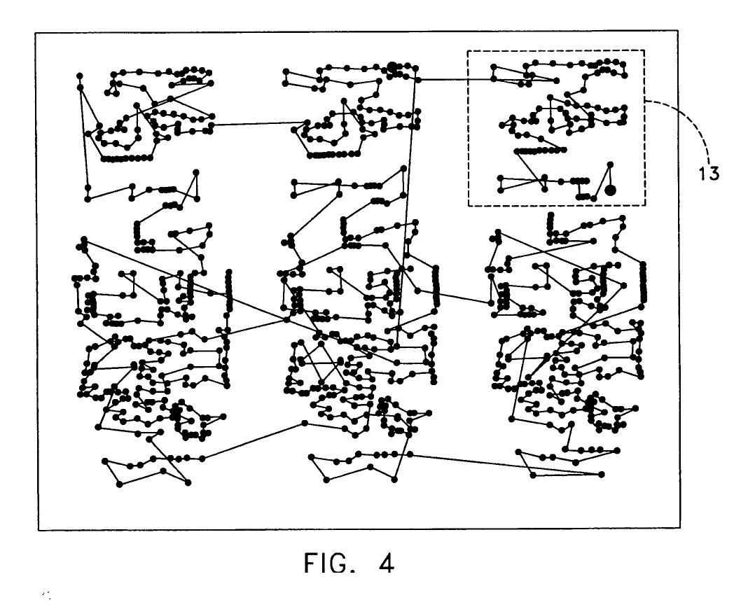

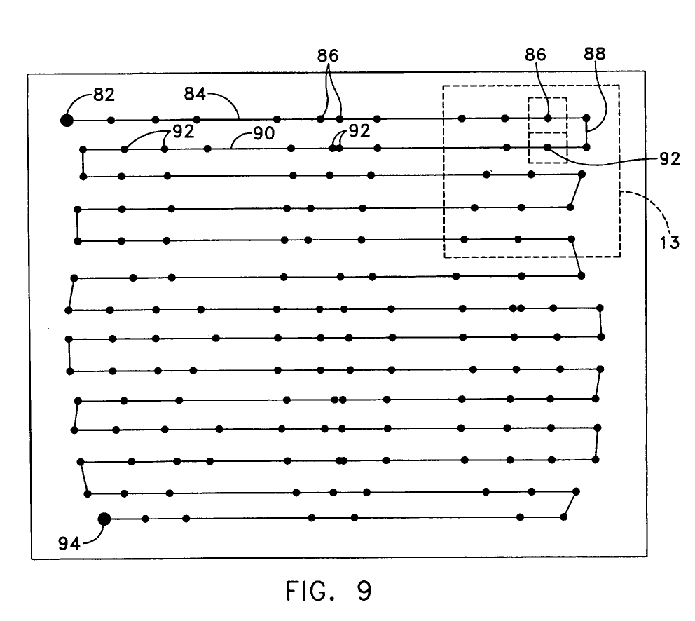

Turning now to FIG. 9, there is illustrated an optimal scan path that is performed by the imaging system 50 under the operation of the controller 34 pursuant to the teachings of the present invention. With this particular example, the circuit board 12 illustrated in FIG. 3 is being scanned for inspection. However, it should be understood that other objects or devices may be scanned, such as the stencil, instead of the circuit board 12, and benefit from the optimal scan path system and method of the present invention. As shown in FIG. 9, the imaging system 50 begins at a starting point 82, and travels along an axis 84 from the starting point over the circuit board in a first direction, which in the exemplary embodiment is left-to-right in FIG. 9. This axis 84 is sometimes referred to as a “first axis” herein. The starting point 82 begins adjacent the top of the circuit board, near the upper, left-hand corner. However, the initiation of the optimal scan of the circuit board and/or stencil may be initiated at any point over the object being scanned. As the imaging system travels, it captures images of regions of interest along the first axis 84.

Referring back to FIG. 3, the circuit board may be populated with hundreds, if not thousands, of electronic components. As discussed above, these components are attached to electronic pads provided on the circuit board, and the solder paste is adapted to be deposited onto the pads in the manner described above to secure the components to the pads. The controller 34 is configured to identify the outer periphery of the pads on the board so as to define the boundaries of the images to be taken. Once the boundaries are defined, the controller 34 identifies regions of interest (e.g., a pad or multiple pads having solder paste deposits) along the first axis 84 to capture images of all of the regions of interest provided along the first axis. As shown in FIG. 9, there are twelve such regions of interest, each indicated at 86, provided along the first axis 84. FIG. 9 represents the imaging system 50 traveling along a horizontal- or x-axis, which is typically referred to as a “primary” or “fast” axis movement in the art. The imaging system and the gantry system may be configured so that the vertical- or y-axis is the “fast axis” movement and the resulting scan path captures images along the vertical axis instead of the horizontal axis. However, although illustrated as straight and horizontal in FIG. 9, the first axis 84 may be configured so that it is non-linear and/or disposed along an axis that is at an angle with respect to the first axis and still fall within the scope of the present invention. Also, the length of the first axis movement of the imaging system 50 may be shorter or longer than the length of movement shown in FIG. 9.

Once all of the regions of interests 86 are captured along the first axis 84, the imaging system 50, under the direction of the controller 34 via the gantry system 52, moves orthogonally along a vertical- or y-axis direction 88 away from the first axis. This direction of movement of the imaging system 50 may be referred to as a “secondary” or “slow” axis movement. The controller 34, or the operator of the stencil printer 30, predetermines a distance of movement so that there is no space between images of adjacent regions of interest, and deliberate space with higher speed transition in areas where no regions of interest exist. As shown in FIG. 9, the lower edge of a region of interest 86 taken along the first axis 84, may at least abut (and, in certain embodiments, overlap) the upper edge of an adjacent region of interest. As with the first axis 84, the secondary axis movement may be configured so that it is non-linear and/or disposed along an axis that is at an angle to a vertical axis. In addition, the length of the secondary axis movement may be shorter or longer than the movement length shown in FIG. 9, depending on the location of the regions of interest and the capabilities of the imaging system 50. Specifically, as shown in FIG. 9, some of the secondary axis movements are not vertical, but nearly vertical. In such instances, the secondary axis movement may also incorporate a slight primary axis movement.

Once moved in the y-axis direction, the imaging system 50, under the direction of the controller 34, moves along a second axis 90 in a second direction, which is opposite the first direction described above (e.g., right-to-left as shown in FIG. 9). As with the imaging of regions of interest along the first axis 84, the controller 34 identifies regions of interest, each indicated at 92, along the second axis 90 to capture images of each region of interest. As shown, there are eleven such regions of interest 92 along the second axis 90.

The imaging system 50 moves under the direction of the controller 34 to scan the remaining surface of the circuit board 12. Specifically, the imaging system 50, after moving a predetermined distance in a vertical- or y-axis direction, moves along another horizontal- or x-axis direction in the first direction, and captures images of the regions of interest along the axis of movement. Once imaging along the axis is completed, the imaging system makes another vertical- or y-axis movement and moves along a horizontal- or x-axis in the second direction. This pattern of movement, as clearly illustrated in FIG. 9, continues until the circuit board is completely scanned. As shown, the entire surface of the circuit board is not completely scanned, only those areas requiring inspection, e.g., a solder paste deposit on a metallic pad of the circuit board. The end point of the scanning process is indicated at 94. For the circuit board 12, the imaging system 50, under the direction of the controller 34, makes a total of fourteen scan passes and captures images of 148 regions of interest.

Once the imaging system 50 obtains images of all of the regions of interest as selected or otherwise identified by the controller 34, for example, the images may be assembled together, or utilized in a piecemeal fashion by the controller. The controller 34 may perform an inspection analysis of the particular operation performed on the circuit board. In a certain embodiment, the analysis may include inspecting the accuracy of a solder paste deposit onto a metallic pad of the circuit board, or performing a texture recognition analysis, which will be discussed in greater detail below. As discussed above, the imaging system 50 may be configured to move from one region of interest to the next region of interest, and captures an image of the region of interest while maintaining a minimum velocity. The provision of the optimal scan path and the imaging system configuration greatly enhances inspection efficiency.

As discussed above, the foregoing optimal scanning system and method may be conducted on the stencil 14 or 36 as well as the circuit board 12. In addition, the stencil printer 30 may be configured so that the “fast” axis movement is in the vertical- or y-axis direction instead of the horizontal- or x-axis direction described above.

The resulting effect of employing the optimal scan path system and method is a significant decrease in the time required to inspect the circuit board 12 shown in FIG. 3. As mentioned above, utilizing well-known stencil printer scanning methods result in identifying and capturing images of 921 regions of interest. Using such scanning methods, the time required to inspect the circuit board takes approximately 260 seconds (over four minutes). Referring to FIG. 9, by utilizing the optimal scan path technique discussed herein, the regions of interest are reduced to 148 sites. Consequently, the time required to scan the circuit board is reduced to approximately nineteen seconds. The ability of the imaging system to achieve a minimum velocity while scanning also contributes to reducing the time to scan the circuit board.

Turning now to FIG. 10, there is generally indicated at 100 a method for dispensing or depositing solder paste onto electronic pads of a substrate, such as circuit board 12. At 102, a circuit board is delivered to the stencil printer via a transport system employing conveyor rails, for example. At 104, the circuit board is positioned on the support assembly within the stencil printer. At 106, a print operation is performed on the circuit board by employing the dispensing head in the manner described above to deposit solder paste onto the pads of the circuit board.

Once printing is complete, at 108, the imaging system is moved in a first direction along a first axis to capture images of regions of interest (selectively identified by the controller, for example) along the first axis. Specifically, the imaging system, under the direction of the controller, moves from region of interest to region of interest in the manner discussed above. After capturing images of all of the regions of interest along the first axis, the imaging system is move orthogonally away from the first axis a predetermined distance. At 110, the imaging system is then moved in a second direction, opposite to the first direction, along a second axis to capture images of regions of interest selectively identified by the controller along the first axis.

At 112, this process of moving the imaging system back and forth over the object requiring imaging, e.g., the circuit board or the stencil, continues until all of the regions of interest are imaged. As images are accumulated, the controller may assemble the images or otherwise manipulate the images to inspect the imaged object. At 114, the scanning process is completed. For example, in one embodiment, each region of interest may be inspected to ensure that a solder paste deposit is successfully positioned over a metallic pad of the circuit board. This particular process may be enhanced by performing a texture recognition sequence to determine the accuracy of the solder paste deposit on its particular pad. In another embodiment, the regions of interest may include apertures of the stencil, and the inspection process may embody determining whether the apertures are clogged with solder paste.

In one embodiment, the imaging system 50 may be used to perform a texture recognition method, such as the method disclosed in U.S. Pat. No. 6,738,505 to Prince, entitled METHOD AND APPARATUS FOR DETECTING SOLDER PASTE DEPOSITS ON SUBSTRATES, which is owned by the assignee of the present invention and incorporated herein by reference. U.S. Pat. No. 6,891,967 to Prince, entitled SYSTEMS AND METHODS FOR DETECTING DEFECTS IN PRINTED SOLDER PASTE, which is also owned by the assignee of the present invention and incorporated herein by reference, furthers the teachings of U.S. Pat. No. 6,738,505. Specifically, these patents teach texture recognition methods for determining whether solder paste is properly deposited onto predetermined regions, e.g., copper contact pads, located on a printed circuit board.

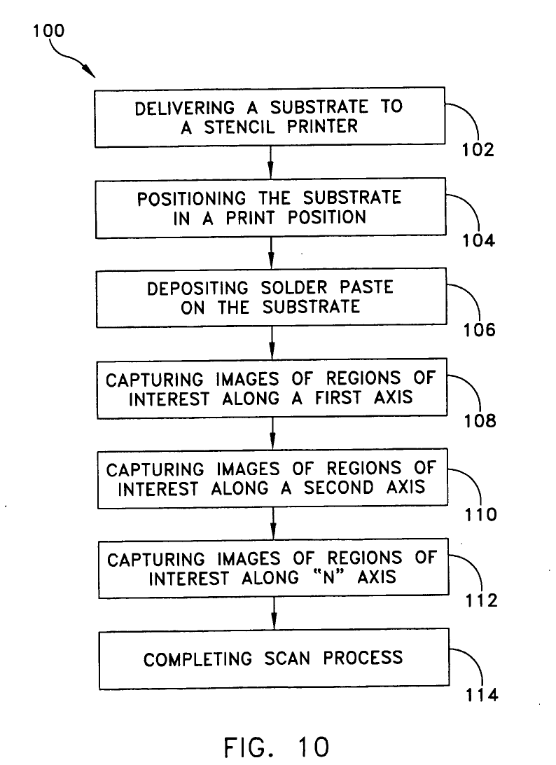

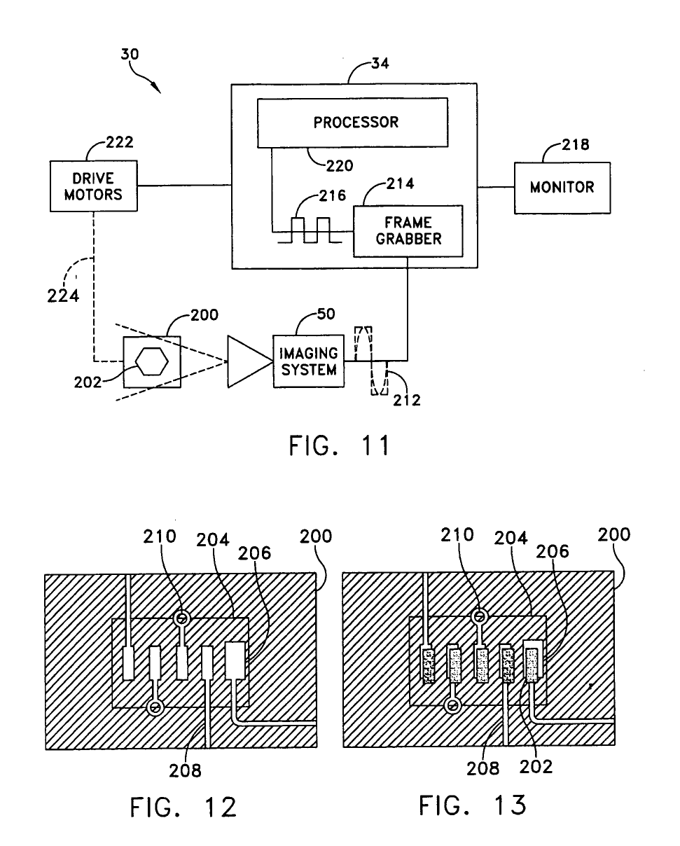

With reference to FIG. 11, in one embodiment, the screen printer 30 is shown inspecting a substrate 200 having a substance 202 deposited thereon. The substrate 200 may embody a printed circuit board (e.g., circuit board 12), wafer, or similar flat surface, and the substance 202 may embody solder paste, or other viscous materials, such as glues, encapsulents, underfills, and other assembly materials suitable for attaching electronic components onto metallic pads of printed circuit boards or wafers. As shown in FIGS. 12 and 13, the substrate 200 has a region of interest 204 and contact regions 206. The substrate 200 further includes traces 208 and vias 210, which are used to interconnect components mounted on the substrate, for example. FIG. 12 illustrates the substrate 200 without substances deposited on any of the contact regions 206. FIG. 13 illustrates the substrate 200 having substances 202, e.g., solder paste deposits, distributed on the contact regions 206. In the substrate 200, the contact regions 206 are distributed across a designated region of interest 204.

FIG. 13 shows a misalignment of the solder paste deposits 202 with the contact regions 206. As shown, each of the solder paste deposits 202 partially touches one of the contact regions 206. To ensure good electrical contact and to prevent bridging between adjacent contact regions, e.g., copper contact pads, the solder paste deposits should be aligned to respective contact regions within specific tolerances. Texture recognition methods of the types disclosed in U.S. Pat. Nos. 6,738,505 and 6,891,967 detect misaligned solder paste deposits on contact regions, and as a result, generally improve the manufacturing yield of the substrates.

Referring back to FIG. 11, in one embodiment, a method for solder paste texture recognition includes using the imaging system 50 to capture an image of the substrate 200 having a substance 202 deposited on the substrate. The imaging system 50 may be configured to transmit a real-time signal analog or digital 212 to an appropriate digital communication port or dedicated frame grabber 214. The digital port may include types commonly known as USB, Ethernet, or Firewire (IEEE 1394). The real-time signal 212 corresponds to an image of the substrate 200 having the substance deposited thereon. Once received, the port or frame grabber 214 creates image data 216 which may be displayed on a monitor 218. In one embodiment, the image data 216 is divided into a predetermined number of pixels, each having a brightness value from 0 to 255 gray levels. In one embodiment, the signal 212 represents a real-time image signal of the substrate 200 and the substance 202 deposited thereon. However, in other embodiments, the image is stored in local memory and transmitted to the controller 34 on demand, as required.

The port or frame grabber 214 is electrically connected to the controller 34, which includes a processor 220. The processor 220 calculates statistical variations in texture in the image 216 of the substance 202. The texture variations in the image 216 of the substance 202 are calculated independent of relative brightness of non-substance background features on the substrate 200, thereby enabling the processor 220 to determine the location of the substance on the substrate and compare the location of the substance with a desired location. In one embodiment, if the comparison between the desired location and the actual location of the substance 202 reveals misalignment exceeding a predefined threshold, the processor 220 responds with adaptive measures to reduce or eliminate the error, and may reject the substrate or trigger an alarm via the controller 34. The controller 34 is electrically connected to drive motors 222 of the stencil printer 30 to facilitate the alignment of the stencil 36 and the substrate 200 as well as other motion related to the printing process.

The controller 34 is part of a control loop 224 that includes the drive motors 222 of the stencil printer 30, the imaging system 50, the frame grabber 214 and the processor 220. The controller 34 sends a signal to adjust the alignment of the stencil 36 should the substance 202 be misaligned with the contact region 206.

During operation, when depositing a substance on a substrate, an image is captured of the substance deposit. In one embodiment, the substance is solder paste and the substrate is a printed circuit board. The image of the substrate with the substance may be captured in real-time or retrieved from memory of the controller. The image is sent to the processor of the controller in which texture variations in the image are detected. These texture variations are used to determine the location of the substance on the substrate. The processor is programmed to compare the particular location of the substance with predetermined locations of the substrate. If variations are within predetermined limits, the processor may respond with adaptive measures to refine the process. If the variations lie outside predetermined limits, then an appropriate recovery measure may be employed in which the substrate is rejected, the process is terminated, or an alarm is triggered. The controller is programmed to perform any one or more of these functions if a defect is detected.

Thus, it should be observed that the imaging system 50 of the present invention is particularly suited for capturing sharply focused and blur-free images as required to perform texture recognition methods while providing efficient real-time, closed-loop control, since the imaging system is capable of quickly imaging regions of interest (predefined areas) so that data can be quickly analyzed.

In one embodiment, the stencil and/or the circuit board may move relative to the camera to take images of the stencil and the board, respectively. For example, the stencil may be translated away from the print nest and moved over or under the camera, which may be stationary. Similarly, the circuit board may be shuttled away from the print nest and moved over or under the camera. The camera may then take an image of the stencil and/or circuit board in the manner described above, with the circuit board and/or stencil maintaining a minimum velocity.

In another embodiment, the imaging system may be employed within a dispenser designed to dispense viscous or semi-viscous materials, such as solder paste, glues, encapsulents, underfills, and other assembly materials on a substrate, such as a printed circuit board. Such dispensers are of the type sold by Speedline Technologies, Inc., under the brand name CAMALOT®.

The improved optical scanning efficiency, mechanical stability, and parallel operation afforded by this invention reduces the time required to acquire images of both the electronic substrate and the stencil to less than a one-tenth of the time required when using prior imaging systems and methods. For example, stop and go methods require delays to allow any residual oscillation to dissipate before capturing the image of the region of interest. Also, inefficient scanning paths further increase the time required to scan the object. The systems and methods of embodiments of the present invention significantly decrease the time required to capture images, while maintaining the quality of the captured image.

While this invention has been shown and described with references to particular embodiments thereof, those skilled in the art will understand that various changes in form and details may be made therein without departing from the scope of the invention, which is limited only to the following claims.

What is claimed is:

1. A stencil printer for depositing solder paste onto a plurality of pads of an electronic substrate, the stencil printer comprising:
a frame;
a stencil coupled to the frame, the stencil having a plurality of apertures formed therein;
a dispenser coupled to the frame, the dispenser and the stencil being constructed and arranged to deposit solder paste onto the plurality of pads of the electronic substrate;
an imaging system constructed and arranged to capture images of regions of interest of at least one of the electronic substrate and the stencil; and
a controller coupled to the imaging system, the controller being constructed and arranged to control movement of the imaging system to capture images of regions of interest of at least one of the electronic substrate and the stencil extending generally along a first axis before moving the imaging system in another direction.

2. The stencil printer of claim 1, wherein, after capturing images of all of the regions of interest along the first axis, the controller is further constructed and arranged to control movement of the imaging system to capture images of regions of interest extending generally along a second axis, which is generally parallel to and spaced a distance from the first axis.

3. The stencil printer of claim 1, wherein the imaging system is constructed and arranged to capture an image of solder paste on a pad of the electronic substrate within the area.

4. The stencil printer of claim 1, wherein the imaging system comprises at least one camera, at least one lens assembly, at least one illumination device and at least one optical path adapted to reflect light between the at least one illumination device, one of the stencil and the electronic substrate, the at least one lens assembly, and the at least one camera.

5. The stencil printer of claim 4, wherein the optical path comprises at least one beam splitter and a mirror.

6. The stencil printer of claim 1, wherein the imaging system comprises:
a first camera, a first lens assembly, a first illumination device and a first optical path adapted to reflect light between the first illumination device, the electronic substrate, the first lens assembly and the first camera, and
a second camera, a second lens assembly, a second illumination device, and a second optical path adapted to reflect light between the second illumination device, the stencil, the second lens assembly and the second camera.

7. The stencil printer of claim 6, wherein the controller is further constructed and arranged to control the movement of the imaging system to simultaneously capture images of regions of interest of the electronic substrate and the stencil.

8. The stencil printer of claim 1, wherein the controller comprises a processor programmed to perform texture recognition of the electronic substrate to determine the accuracy of the solder paste deposits on the pads of the electronic substrate.

9. The stencil printer of claim 1, further comprising a support assembly coupled to the frame, the support assembly being adapted to support the electronic substrate in a printing position.

10. The stencil printer of claim 1, wherein the controller is further constructed and arranged to control the movement of the imaging system to capture images of regions of interest while maintaining a minimum velocity above zero when moving from one region of interest to a next region of interest.

11. The stencil printer of claim 1, further comprising a gantry system coupled to the imaging system and the frame, the gantry system being constructed and arranged to move the imaging system under the direction of the controller.

12. A method for dispensing solder paste onto electronic pads of an electronic substrate, the method comprising:
delivering an electronic substrate to a stencil printer;
positioning the electronic substrate in a print position;
positioning a stencil onto the electronic substrate;
performing a print operation to deposit solder paste onto the pads of the electronic substrate;
capturing images of regions of interest of one of the electronic substrate and the stencil generally along a first axis; and
capturing images of regions of interest of the one of the electronic substrate and the stencil generally along a second axis, which is generally parallel to and spaced a distance from the first axis.

13. The method of claim 12, wherein capturing images of regions of interest of one of the electronic substrate and the stencil along both of the first and second axes comprises moving an imaging system from one region of interest to a next region of interest.

14. The method of claim 13, further comprising maintaining a minimum velocity above zero when moving the imaging from one region of interest to the next region of interest.

15. The method of claim 12, further comprising, after capturing images of regions of interest of one of the electronic substrate and the stencil, moving the imaging system in a direction that is generally orthogonal to the first axis.

16. The method of claim 12, further comprising assembling the captured images of the regions of interest.

17. The method of claim 12, further comprising performing a texture recognition sequence of the at least one area to determine the accuracy of the solder paste deposits on the pads of the electronic substrate.

18. A stencil printer for depositing solder paste onto a plurality of pads of an electronic substrate, the stencil printer comprising:
a frame;
a stencil coupled to the frame, the stencil having a plurality of apertures formed therein;
a dispenser coupled to the frame, the dispenser and the stencil being constructed and arranged to deposit solder paste onto the plurality of pads of the electronic substrate;
an imaging system constructed and arranged to capture images of regions of interest of at least one of the electronic substrate and the stencil; and
means for controlling the movement of the imaging system to capture images of regions of interest of at least one of the electronic substrate and the stencil extending generally along a first axis before moving the imaging system in a direction that is generally orthogonal to the first axis.

19. The stencil printer of claim 18, wherein the means for controlling the movement of the imaging system comprises a controller coupled to the imaging system.

20. The stencil printer of claim 19, wherein the controller is further constructed and arranged to control movement of the imaging system to capture images of regions of interest extending generally along a second axis, which is generally parallel to and spaced a distance from the first axis.

21. The stencil printer of claim 19, wherein the imaging system is constructed and arranged to capture an image of solder paste on a pad of the electronic substrate within the area.

22. The stencil printer of claim 19, wherein the imaging system comprises at least one camera, at least one lens assembly, at least one illumination device and at least one optical path adapted to reflect light between the at least one illumination device, one of the stencil and the electronic substrate, the at least one lens assembly, and the at least one camera.

23. The stencil printer of claim 22, wherein the optical path comprises at least one beam splitter and a mirror.

24. The stencil printer of claim 19, wherein the imaging system comprises:
a first camera, a first lens assembly, a first illumination device and a first optical path adapted to reflect light between the first illumination device, the electronic substrate, the first lens assembly and the first camera, and
a second camera, a second lens assembly, a second illumination device, and a second optical path adapted to reflect light between the second illumination device, the stencil, the second lens assembly and the second camera.

25. The stencil printer of claim 24, wherein the controller is further constructed and arranged to control the movement of the imaging system to simultaneously capture images of regions of interest of the electronic substrate and the stencil.

26. The stencil printer of claim 19, wherein the controller comprises a processor programmed to perform texture recognition of the electronic substrate to determine the accuracy of the solder paste deposits on the pads of the electronic substrate.

27. The stencil printer of claim 19, further comprising a support assembly coupled to the frame, the support assembly being adapted to support the electronic substrate in a printing position.

28. The stencil printer of claim 19, wherein the controller is further constructed and arranged to control the movement of the imaging system to capture images of regions of interest while maintaining a minimum velocity above zero when moving from one region of interest to a next region of interest.

29. The stencil printer of claim 19, further comprising a gantry system coupled to the imaging system and the frame, the gantry system being constructed and arranged to move the imaging system under the direction of the controller.

30. A stencil printer for depositing solder paste onto a plurality of pads of an electronic substrate, the stencil printer comprising:
a frame;
a stencil coupled to the frame, the stencil having a plurality of apertures formed therein;
a support assembly coupled to the frame, the support assembly being adapted to support the electronic substrate in a printing position;
a dispenser coupled to the frame, the dispenser and the stencil being constructed and arranged to deposit solder paste onto the plurality of pads of the electronic substrate;
an imaging system constructed and arranged to capture images of regions of interest of at least one of the electronic substrate and the stencil;
a gantry system coupled to the imaging system and the frame, the gantry system being constructed and arranged to move the imaging system; and
a controller coupled to the imaging system and the gantry system, the controller being constructed and arranged to control movement of the imaging system to capture images of regions of interest extending generally along a first axis in a first direction and to sequentially control movement of the imaging system to capture images of regions of interest extending generally along a second axis, which is generally parallel to and spaced from the first axis, in a second direction.

31. The stencil printer of claim 30, wherein the controller comprises a processor programmed to perform texture recognition of the electronic substrate to determine the accuracy of the solder paste deposits on the pads of the electronic substrate.

32. The stencil printer of claim 30, wherein the controller is further constructed and arranged to control the movement of the imaging system to simultaneously capture images of regions of interest of the electronic substrate and the stencil.

33. The stencil printer of claim 30, wherein the controller is further constructed and arranged to control the movement of the imaging system to capture images of regions of interest while maintaining a minimum velocity above zero when moving from one region of interest to a next region of interest.
